(19) United States
(12) Patent Application Publication
(10) Pub. No.: US 2005/0171689 A1
(43) Pub. Date: Aug. 4, 2005

(54) Arrangement for indicating hits

(75) Inventor: Micael Malmberg, Orlando, FL (US)

Correspondence Address: BURNS DOANE SWECKER & MATHIS L L P, POST OFFICE BOX 1404, ALEXANDRIA, VA, 22313-1404, US

(73) Assignee: SAAB AB, Linkoping (SE)

(21) Appl. No.: 10/767,950

(22) Filed: Jan. 30, 2004

(51) Int. Cl. G01C 21/26

(52) U.S. Cl. 701/207

(57) ABSTRACT

The present invention relates to an arrangement for indicating hitting of a target such as a vehicle in the form of, for example, a tank, a tracked vehicle, a truck or other wheeled vehicle. The arrangement comprises a heatable body mounted on the target and arranged to thermally indicate hit.

### TECHNICAL FIELD

The present invention relates to an arrangement for indicating hitting of a target such as a vehicle in the form of, for example, a tank, a tracked vehicle, a truck or other wheeled vehicle.

A number of examples of target types have been given above. However, there are many other possible types, and we do not exclude, for example, seagoing targets or target systems on soldiers or targets such as buildings, bridges or bunkers.

### PRIOR ART

For military field exercises, there are outdoor simulators which are used for tanks and other artillery weapons and which transmit hit codes to each target. The action of the weapon on the target can be transmitted in several different ways depending on which type of known simulator is chosen. For example, the target can be provided with one or more strips of detectors for detecting incident illuminating electromagnetic radiation, and, if said detected incident electromagnetic radiation satisfies defined detection criteria, this is indicated by means of the light source mounted on the target. In the case wherein the target is a tank, the strips are preferably mounted horizontally on the tank turret, along the front of the tank, the sides and rear. Another alternative of transmitting the action on the target is, in conjunction with a simulator system, to transmit the position of the weapon impact via electromagnetic radiation, for example as coordinates via radio. The last-mentioned case is customary, for example, for simulation of artillery or minefields.

A target which has been hit must indicate in an unambiguous manner that it has been taken out in known methods and arrangements for indicating hits, the status of the target can be marked by means of lights with rotating reflectors or by means of flashing lights. Such lights can function by flashing a few times if the hit does not result in the target being taken out, and by flashing continuously in the event of a hit which results in the target being taken out or, for example, when the crew of a target does something which is not permitted and can be classed as cheating. The lights should be mounted such that they are in fill view. In an example, wherein the target is a tank, the lights are mounted on the roof of the tank turret.

WO 02/079712 describes another light source arrangement for indicating hits. The arrangement is formed by a plurality of light points, such as light-emitting diodes, which are distributed and mounted on one or more of the above discussed strips. By arranging the light source in the strips and distributing its light points along the strips, a hit indicating arrangement is obtained which is not based on the roof and which can provide indications all around.

One object of the invention is to further increase the visibility of the hit indicating system to soldiers participating in military field exercises.

### SUMMARY OF THE INVENTION

This is achieved with an arrangement for indicating hitting of a target such as a vehicle in the form of, for example, a tank, a tracked vehicle, a truck or other wheeled vehicle, said arrangement comprising a heatable body mounted on the target, said heatable body being arranged to thermally indicate hit. A number of examples of target types have been given above. However, there are many other possible types, and we do not exclude, for example, seagoing targets or target systems on soldiers or targets such as buildings, bridges or bunkers.

The heatable body can be arranged to be heated for a few seconds if the hit does not result in the target being taken out and to be heated for a longer time, for example till the field exercise is over, in the event of a hit which results in the target being taken out or, for example, when the crew of the target does something which is not permitted and can be classed as cheating. Thereby, when viewing the thermal hit indicating means through a thermal sight (Forward Looking Infrared, FLIR) of a shooting simulator system, the shooter can determine whether a simulated shot has resulted in a hit. Further, the shooter can realize which potential targets have already been taken out and thus determine which targets it is meaningful to fight. As today thermal sights are used over 50% of the time, the value of the training is considerably increased using the arrangement for thermally indicating hits.

The arrangement for thermally indicating hits can advantageously be combined with a conventional hit indicating device emitting visible light and activated on the same criteria as the arrangement for thermally indicating hits.

The heatable body can be enclosed in a rotating cover arranged to rotate about the heated body. The cover is provided with at least one opening, for example shaped as a slit, through which the heated body can be detected. Thereby, the image of a flashing light is created when viewing the thermal hit indicator through a thermal sight. The heatable body comprises for example an electrically heatable folio.

In order to ensure detection by the thermal sight the inner surface of the cover and the enveloping surface of the heatable body are preferably of the same shape. However, sufficient function can be provided with a heatable body of another design. There should be a gap between the inner surface of the cover and the enveloping surface of the heat source in order to ensure that the cover is freely rotatable around the body.

The cover and body are in accordance with one embodiment of the invention cylinder shaped, but also other designs are possible. For example the cover and body can be shaped as a sphere or a half-sphere.

The invention will be described in greater detail below with reference to a number of illustrative embodiments.

### SHORT DESCRIPTION OF THE DRAWING

FIG. 1 shows an example of an arrangement according to the invention for indicating hits, mounted an a tank.

FIG. 2 shows an example of a thermal hit indication device in the arrangement of FIG. 1.

FIG. 3 shows schematically an example of how the arrangement for indicating hits according to the invention can be configured in principle.

### PREFERRED EMBODIMENTS

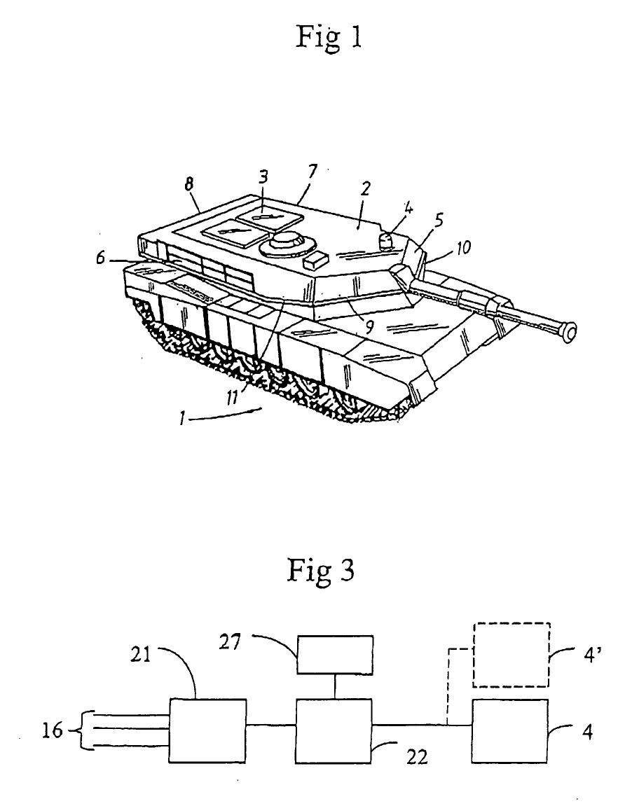

A target in the form of a tank 1 which is equipped with an arrangement for indicating hits is shown in FIG. 1. A thermal hit indicating device 4 is provided on the roof 2 of the turret 3 of the tank 1. A number of horizontal strips are arranged on the front 5, sides 6, and 7 and rear 8 of the turret 3, of which three strips can be seen in the Figure, namely strips 9 and 10 on the front 5 of the turret and the strip 11 on one side of the turret 3. The strips 9, 10, 11 are provided with a number of detectors 16 (see FIG. 3) preferably of the photodiode type. Laser light incident on the detectors is detected by said detectors and triggers activation of the thermal hit indicating device 4 if the detected signal satisfies preset detection criteria The detection criteria can in principle be chosen with a great degree of freedom. The object is to set criteria which to the greatest possible extent filter out interference and at the same time ensure that transmitted hit codes are reliably identified.

In the shown example, the thermal hit indicating device 4 is mounted on the roof 2 of the tank 1. Even though it is advantageous positioning the device 4 on the roof, as it is visible from positions all around the tank, the device 4 can be mounted on other locations on the tank. In order to be visible from all views, the single thermal hit indicating device can be substituted with several identical devices 4 distributed on the tank.

In some situations, for example when the target is intended as a target for flying objects, it can be desirable that the target is provided only with the thermal hit indicator 4 and not with a conventional hit indicator arranged to emit flashing light, as a pilot using a light amplifier can be dazzled by the flashing light. In other situations, and for other tapes of targets, the target is preferably provided with one or more thermal hit indicators and one or more conventional bit indicators. Then the state of the target (eg hit, taken out) is visible both from thermal sights and conventional sights, thereby increasing the exercising value.

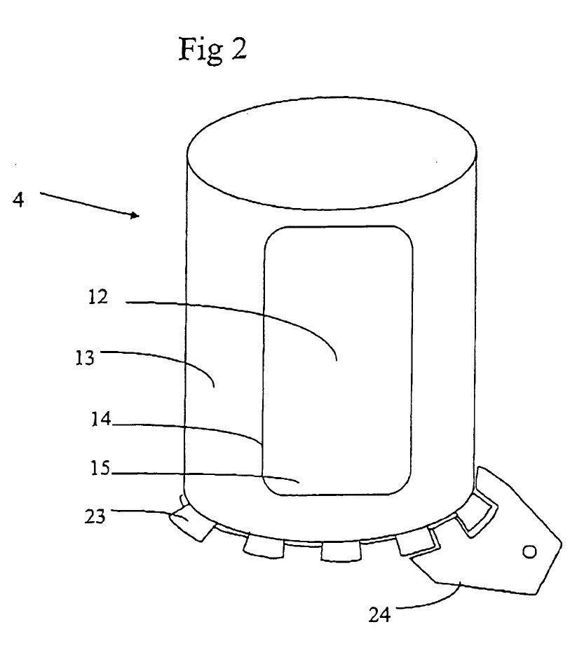

In FIG. 2, the thermal hit indicating device 4 comprises a heatably body 12. The body 12 is arranged to be heated upon activation based on the detection criteria. The body 12 is for example heated to a temperature of 20° C. above the temperature of the surroundings.

A hollow cylinder, or sleeve, 13 is arranged outside the heatable body 12. The cylinder/sleeve 13 is formed in a material not absorbing the heat from the body 12. For example, the hollow cylinder/sleeve 13 can for example be made of aluminium or of light weight fiber material with a metal folio. The height of the cylinder is approximately 300 mm or more. The cylinder/sleeve 13 is provided with a longitudinally extending slit 14. In the shown example, the slit 14 extends substantially over the whole length of the cylinder/sleeve. Alternatively, the slit 14 can be divided into two or more slits each extending over a part of the cylinders length. In yet another example two or more longitudinally extending slits 14 are parallelly distributed on the side surface of the cylinder. Further, the slits can be extending over the side surface in a non-longitudinal direction. The width of each slit is for example within a range 40 mm to 100 mm. The height of the slit is critical due to constraints in the resolution of the thermal sight. For thermal sights on the markets today, the height of the slit should be about 300 mm in order to ensure that the body 12 can be properly detected. However, the art of designing openings in the cylinder/sleeve 13 for providing optimal thermal detection of the heatable body 12 is not part of this invention. It is at the discretion of the person skilled in the art practicing the invention to perform tests ensuring that the thermal hit indication device 4 is visible in those thermal sights intended for use with the thermal hit indicating device

The cylinder/sleeve 13 is farther arranged to rotate around its axle. Thereby, when viewing the thermal hit indicating device 4 through a thermal sight (Forward Looking Infrared, FLIR) a flashing light effect appears in the sight, wherein the flashing frequency is determined by the rotating speed of the cylinder/sleeve and the number of slits distributed over the cylinder side surface. The rotating speed lies for example within the range 30 to 120 rotations per minute. However, it has to be ensured that the thermal sight intended for use is able to register the thermal indication using the chosen rotating speed, otherwise the rotating speed has to bee decreased.

In order to rotate around its axis, the, cylinder/sleeve 13 is provided with a gear-wheel 23 arranged to cooperate with a pinion 24 driven by an electrical motor (not shown). The motor is in one example arranged to be activated based on the same criteria as the activation of the heatable body, in which case the cylinder/sleeve is caused to rotate when the target is hit or otherwise taken out.

The heatable body comprises a core (not shown) enclosed by an electrically heated folio 15. The core is preferably not heat absorbing. The folio 15 is electrically leading and for example made by a metal material such as aluminum. The body 12 is preferably designed as a cylinder having a somewhat smaller diameter than the inner diameter of the hollow cylinder/sleeve 13 partially enclosing it.

Of course other types of heat sources than the electrically heated folio can be used, for example, a conventional heating element can be used. However, the electrically heated folio has the advantage that the power consumption can be held at a low level and that the folio can be heated up in a short amount of time.

In an alternative embodiment, the heatable body 12 is arranged to rotate together with the cylinder/sleeve 13. In this embodiment the folio 15 only needs to at least partly cover the slit 14 or slits and not the entire body surface.

FIG. 3 shows schematically a possible design of the arrangement for indicating hits. The detectors 16 arranged in the strips 9, 10, 11 are coupled to a common amplifier 21. The amplified detector signal is fed to a processor 22, preferably a microprocessor, placed in the tank. On the basis of the received signal and the defined activation criteria, the processor 22 is programmed to determine whether the thermal hit indicating device 4 is to be activated in order to indicate hit and, if so activate the hit indicating device 4. The activation criteria can be defined such that the thermal hit indicating device 4 is activated for a few seconds if the hit does not result in the target being taken out and such that the thermal lit indicating device 4 is “permanently” activated in the event of a hit which results in the target being taken out or, for example, when the crew of the target does something which is not permitted and can be classed as cheating. The “permanently” activated thermal hit indicating device can of course be manually deactivated for example at the end of a field exercise.

Further, the arrangement of the invention can also include a hit indication device 4′ arranged to emit visible light upon activation by the processor 22.

In the embodiments described in detail above, it has been assumed as the main solution that the target is equipped with the target part of a simulator system comprising detectors for electromagnetic radiation, preferably laser radiation, and in this case the device 4 can be constituted of several heated bodies distributed over the strips together with the detectors. However, the invention is not limited to this case, and instead can also advantageously be used as target indicator in simulator systems where the information on hit positions is transmitted in another way, for example via radio.

In an extended embodiment, a radio receiver 27 can be connected to the processor in order to receive hit position coordinates, for example for artillery or minefields. This can be done in combination with use of the detectors, but designs where all the hit position transmission is done via radio can also be advantageous.

The invention is not limited to the embodiments shown above by way of example, and instead it can be modified within the scope of the attached claims.

1. Arrangement for indicating hitting of a target such as a vehicle in the form of, for example, a tank, a tracked vehicle, a truck or other wheeled vehicle, said arrangement comprising a heatable body mounted on the target, said heatable body being arranged to thermally indicate hit.

2. Arrangement according to claim 1, wherein the heatable body is heated upon detection of a hit.

3. Arrangement according to claim 2, wherein the heatable body comprises an electrically heated folio.

4. Arrangement according to claim 2, wherein the heatable body is enclosed in a cover having a slit and being arranged to rotate around the body.

5. Arrangement according to claim 4, wherein the cover is cylinder shaped.

6. Arrangement according to claim 4, wherein the inner surface of the cover and the enveloping surface of the heatable body have the same shape and wherein there exists a gap between the inner surface of the cover and the enveloping surface of the heatable body.

7. A weapon simulation system comprising
at least one weapon comprising means for emitting radiation representative of a simulated weapon effect,
at least one target comprising
means for receiving said radiation and based on said radiation determine hit and, and
an arrangement for indicating said hit, said arrangement comprising a heatable body heated up upon determination of hit.
